(19) United States
(12) Patent Application Publication
(10) Pub. No.: US 2022/0018934 A1
(43) Pub. Date: Jan. 20, 2022

(54) COORDINATED MINI-RADAR TARGET SIMULATORS FOR IMPROVED ACCURACY AND IMPROVED GHOST CANCELLATION

(71) Applicant: Keysight Technologies, Inc., Santa Rosa, CA (US)

(72) Inventors: Gregory S. Lee, Mountain View, CA (US); Gregory Douglas Vanwiggeren, San Jose, CA (US); Ken A. Nishimura, Fremont, CA (US)

(21) Appl. No.: 17/157,160

(22) Filed: Jan. 25, 2021

Related U.S. Application Data
(60) Provisional application No. 63/051,441, filed on Jul. 14, 2020.

(51) Int. Cl. G01S 7/40

(52) U.S. Cl. CPC G01S 7/4026; G01S 7/4021; G01S 2007/403; G01S 2007/4086; G01S 2007/4034; G01S 7/4008

(57) ABSTRACT

A system for testing vehicular radar is disclosed. The system includes a re-illumination element adapted to receive electromagnetic waves, and to transmit response signals. The re-illumination element includes: a plurality of miniature radar target simulators (MRTS's), each comprising: a receive antenna; a variable gain amplifier (VGA); an in-phase-quadrature (IQ) mixer; a variable attenuator; and a transmit antenna. The MRTS's are disposed in an array comprising rows and columns of the MRTS's, and each MRTS of the array is laterally spaced a distance pₓ and vertically spaced a distance p_{y} from an adjacent MRTS. An incremental subtended azimuth angle (δϕ) and an incremental subtended elevation (δθ) angle are finer than an azimuth resolution specification (ϕᵣₑₛ) and an elevation resolution specification (θᵣₑₛ) of a radar device under test (DUT).

### CROSS-REFERENCE TO RELATED APPLICATIONS

The present application claims priority under 35 U.S.C. § 119(e) and under 37 C.F.R. § 1.78(a) to commonly owned U.S. Provisional Application No. 63/051,441 filed on Jul. 14, 2020. The entire disclosure of U.S. Provisional Application No. 63/051,441 is specifically incorporated herein by reference.

### BACKGROUND

Millimeter waves result from oscillations at frequencies in the frequency spectrum between 30 gigahertz (GHz) and 300 gigahertz. Millimeter wave (mmWave) automotive radar is a key technology for existing advanced driver-assistance systems (ADAS) and for planned autonomous driving systems. For example, millimeter wave automotive radar is used in advanced driver-assistance systems to warn of forward collisions and backward collisions. Additionally, millimeter wave automotive radar may be used in planned autonomous driving systems to implement adaptive cruise control and autonomous parking, and ultimately for autonomous driving on streets and highways. Millimeter wave automotive radar has advantages over other sensor systems in that millimeter wave automotive radar can work under most types of weather and in light and darkness. Adaptation of millimeter wave automotive radar has lowered costs to the point that millimeter wave automotive radar can now be deployed in large volumes. As a result, millimeter wave automotive radars are now widely used for long range, middle range and short range environment sensing in advanced driver-assistance systems. Additionally, millimeter wave automotive radars are likely to be widely used in autonomous driving systems currently being developed.

Actual driving environments in which automotive radars may be deployed can vary greatly and many such driving environments may be complex. For example, actual driving environments may contain numerous objects, and some objects encountered in actual driving environments have complicated reflection and diffraction characteristics that affect echo signals. The immediate consequences of incorrectly sensing and/or interpreting echo signals may be that false warnings or improper reactions are triggered or warnings or reactions that should be triggered are not, which in turn can lead to accidents.

Consequently, auto manufacturers and the automotive radar manufacturers are eager to electronically emulate driving conditions to provide automotive radar systems with optimally accurate performance.

Single-target radar emulators are known. Emulating an actual driving scenario, however, necessitates emulating multiple targets. By way of example, there might be an automobile ahead of the radar-equipped vehicle in the same lane, a truck ahead and one lane to the left, a bicyclist ahead and hugging the right lane divider, another vehicle in cross traffic trying to run a red light. Emulating an apparent angle of arrival (AoA) using known devices is slow and unscalable to larger numbers due to the expensive electronics. Moreover, in most known emulators, only an incomplete subset of range, velocity, and AoA is emulated.

What is needed, therefore, is a system for emulating multiple targets encountered by a radar system that overcomes at least the drawbacks of the known radar emulators described above.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a simplified block diagram showing system for testing vehicular radar in accordance with a representative embodiment.

FIG. 1B is a simplified block diagram of an array of miniature radar target simulators (MRTS) in accordance with a representative embodiment.

FIG. 2 is a simplified circuit diagram of an MRTS in accordance with a representative embodiment.

FIG. 3 is a simplified block diagram of adjacent MRTS's used to interpolate an emulated target disposed therebetween in accordance with a representative embodiment.

FIG. 4A shows adjacent offset MRTS's useful to suppress ghost images in accordance with a representative embodiment.

FIG. 4B shows adjacent offset MRTS's disposed in a curved arrangement and useful to suppress ghost images in accordance with a representative embodiment.

FIG. 5 shows emulation of a target consisting of a single MRTS in accordance with a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, or “coupled to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

As described herein in connection with various representative embodiments, a system for testing vehicular radar is disclosed. The system comprises a re-illumination element adapted to receive electromagnetic waves, and to transmit response signals. The re-illumination element comprises: a plurality of miniature radar target simulators (MRTS's), each comprising: a receive antenna; a variable gain amplifier (VGA); an in-phase-quadrature (IQ) mixer; a variable attenuator; and a transmit antenna. The MRTS's are disposed in an array comprising rows and columns of the MRTS's, and each MRTS of the array is laterally spaced a distance pₓ and vertically spaced a distance p_{y} from an adjacent MRTS. An incremental subtended azimuth angle (δϕ) and an incremental subtended elevation (δθ) angle are finer than an azimuth resolution specification (ϕᵣₑₛ) and an elevation resolution specification (θᵣₑₛ) of a radar device under test (DUT).

As described herein in connection with various representative embodiments, a system for testing vehicular radar is disclosed. The system comprises a re-illumination element adapted to receive electromagnetic waves, and to transmit response signals. The re-illumination element comprises: a plurality of miniature radar target simulators (MRTS's), each comprising: a receive antenna; a variable gain amplifier (VGA); an in-phase-quadrature (IQ) mixer; a variable attenuator; and a transmit antenna. The MRTS's are disposed in an array comprising rows and columns of the MRTS's. The VGA and the variable attenuator are configured to control an emulated radar cross section (RCS) of a target, and the plurality of MRTS's of the array are staggered in displacement from a device under test (DUT).

As described herein in connection with various representative embodiments, a system for testing vehicular radar is disclosed. The system comprises a re-illumination element adapted to receive electromagnetic waves, and to transmit response signals. The re-illumination element comprises: a plurality of miniature radar target simulators (MRTS's), each comprising: a receive antenna; a variable gain amplifier (VGA); an in-phase-quadrature (IQ) mixer; a variable attenuator; and a transmit antenna. The MRTS's are disposed in an array comprising rows and columns of the MRTS's, and each MRTS of the array is laterally spaced a distance pₓ and vertically spaced a distance p_{y} from an resolution specification (θᵣₑₛ) of a radar device under test (DUT). The system also comprises a controller comprising a memory that stores instructions, and a processor that executes the instructions. The controller controls the re-illumination element and is configured to perform performance adjacent MRTS. An incremental subtended azimuth angle (δϕ) and an incremental subtended elevation (δϕ) angle are finer than an azimuth resolution specification (ϕᵣₑₛ) and an elevation testing on the vehicular radar that includes a plurality of targets.

Among other benefits, the emulation provided by the systems of the present teachings is based on “coordinated modulation” of the MRTS's described herein. To this end, and as described more fully herein, the modulation of MRTS's disposed in an array to provide a re-illuminator is coordinated to provide angle interpolation, as well as suppression of a multitude of ghost signals

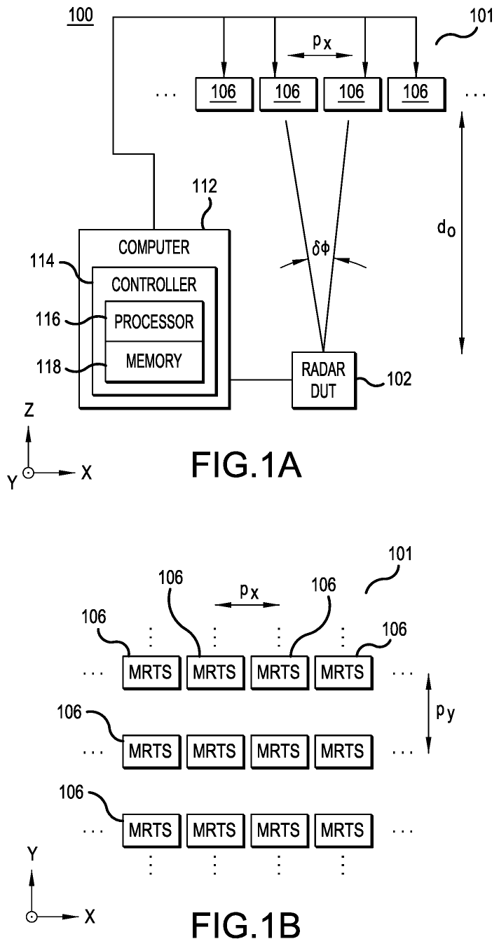

FIGS. 1A-1B are a simplified block diagrams showing system 100 for testing vehicular radar in accordance with a representative embodiment. As will be appreciated by one of ordinary skill in the art having the benefit of the present disclosure, one likely vehicular radar is an automobile radar that is used in various capacities in current and emerging automobile applications. However, it is emphasized that the presently described system 100 for testing vehicular radar is not limited to automobile radar systems, and can be applied to other types of vehicles including busses, motorcycles, motorized bicycles (e.g., scooters), and other vehicles that could employ a vehicular radar system.

In accordance with a representative embodiment, the system 100 is arranged to test a radar device under test (DUT) 102. The system 100 comprises a re-illuminator 101, which comprises an array of MRTS's 106. The array of MRTS's 106 in FIG. 1A is two-dimensional extending in the x-y direction according to the coordinate system of FIG. 1A. As such, FIG. 1B depicts the two-dimensional array of MRTS's 106 from the vantage point of the radar DUT 102 (i.e., in the x-y plane of FIG. 1B). As described more fully below, the MRTS's 106 of the system 100 are adapted to emulate targets in one dimension or two dimensions. Moreover, the array of MRTS's 106 of re-illuminator 101 can be comparatively flat (e.g., in the x-y plane as shown in FIG. 1B), curved in an arc along as a single row array, or curved in two dimensions in an array of multiple columns and rows.

The MRTS's 106 of the array have a lateral spacing pₓ and vertical spacing p_{y} as shown in FIGS. 1A-1B. For reasons described more fully below, the lateral spacing pₓ between adjacent MRTS's 106 is chosen so that the incremental subtended azimuth (δϕ in FIG. 1A) is slightly finer than the azimuth resolution specifications (θᵣₑₛ); and the vertical spacing p_{y} between adjacent MRTS's 106 is slightly finer than the incremental subtended and elevation (δθ, not shown) angles are slightly finer than the elevation resolution (θᵣₑₛ). In accordance with a representative embodiment discussed more fully below, δϕ=ϕᵣₑₛ/2 and δθ=θᵣₑₛ/2.

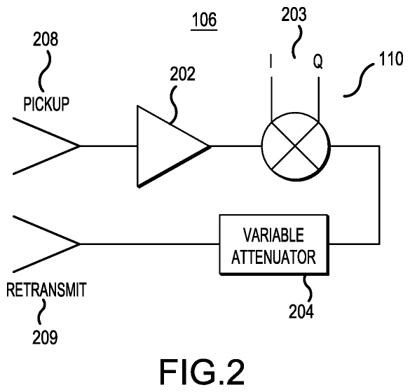

As described below in connection with FIG. 2, each of the MRTS's 106 comprises a transmit antenna (not shown in FIGS. 1A-1B) and a receive antenna (not shown in FIGS. 1A-1B. As described more fully herein, there is one MRTS 106 for each emulated target. The system also comprises a computer 112. The computer 112 illustratively comprises a controller 114 described herein. The controller 114 described herein may include a combination a processor 116 and a memory 118 that stores instructions. The processor 116 executes the instructions in order to implement processes described herein. To this end, in addition to controlling the function of the radar DUT 102, in accordance with a representative embodiment, computer 112 is adapted to control re-illuminator 101. As described more fully below, instructions stored in memory 118 are executed by the processor 116 to alter the signal strength (and thus power) of selected MRSTs 106 by adjusting drive signals from the computer 112 to the MRTS's 106, with weaker drive signals providing comparatively weaker responsive emulation signals, and stronger drive signals providing comparatively stronger responsive emulation signals in accordance with the present teachings. Notably, however, in certain embodiments, comparatively high magnitude drive signals to the I-Q mixers of the MRTS's 106, and emulation strength (and thereby emulated RCS) is adjusted by the VGA. This approach is preferable to lowering the magnitude of the desired stimulus signal by lowering the drive signals to the I-Q mixer, which strengthens the carrier frequency (as noted below), resulting in an undesirable a ghost signal.

The controller 114 may be housed within or linked to a workstation such as the computer 112 or another assembly of one or more computing devices, a display/monitor, and one or more input devices (e.g., a keyboard, joysticks and mouse) in the form of a standalone computing system, a client computer of a server system, a desktop or a tablet. The term “controller” broadly encompasses all structural configurations, as understood in the art of the present disclosure and as exemplarily described in the present disclosure, of an application specific main board or an application specific integrated circuit for controlling an application of various principles as described in the present disclosure. The structural configuration of the controller may include, but is not limited to, processor(s), computer-usable/computer readable storage medium(s), an operating system, application module(s), peripheral device controller(s), slot(s) and port(s).

Additionally, although the computer 112 shows components networked together, two such components may be integrated into a single system. For example, the computer 112 may be integrated with a display (not shown) and/or with the system 100. That is, in some embodiments, functionality attributed to the computer 112 may be implemented by (e.g., performed by) the system 100. On the other hand, the networked components of the computer 112 may also be spatially distributed such as by being distributed in different rooms or different buildings, in which case the networked components may be connected via data connections. In still another embodiment, one or more of the components of the computer 112 is not connected to the other components via a data connection, and instead is provided with input or output manually such as by a memory stick or other form of memory. In yet another embodiment, functionality described herein may be performed based on functionality of the elements of the computer 112 but outside the system 100.

While the various components of the system 100 are described in greater detail in connection with representative embodiments below, a brief description of the function of the system 100 is presented currently.

In operation, with reference to FIGS. 1A-1B, the radar DUT 102 emits signals (illustratively mm wave signals) that are incident on the array of MRTS's 106. As described more fully herein, the signals from the radar DUT 102 are selectively reflected with a power level adapted to emulate the distance, in both azimuth (±x-direction in the coordinate system of FIGS. 1A-1B) and the elevation (±y direction in the coordinate system of FIGS. 1A-1B) between each MRTS 106 and the radar DUT 102. Notably, the respective focal points (alternatively foci) at each one of the receive antennae (not shown in FIGS. 1A, 1B) represents a target that is emulated by the system 100.

The re-illuminated signals from MRTS's 106 that receive signals from the radar DUT 102 are selectively altered by the MRTS's 106 and transmitted back to the radar DUT 102. As described more fully below, the re-illuminated signals from the particular MRTS's 106 of the re-illuminator 101 are received at the radar DUT 102 as emulated reflected signals from targets. The computer 112 receives the signals from the radar DUT 102 for further analysis of the accuracy of the radar DUT 102.

FIG. 2 is simplified circuit diagram of the MRTS 106 of FIGS. 1A-1B, in accordance with a representative embodiment. Aspects of the MRTS 106 described in connection with the representative embodiments may be common to the MRTS's 106 and delay electronics described above, although they may not be repeated. Furthermore, various aspects of the MRTS's 106 (sometimes referred to as MRD's, CMT's and pixels) may be similar to those described in commonly-owned U.S. Provisional Application No. 62/912,442 filed on Oct. 9, 2019; commonly owned U.S. patent application Ser. No. 16/867,804 filed on May 20, 2020; and commonly owned U.S. Provisional Application No. 63/046,301 filed on Jun. 30, 2020. The entire disclosures of U.S. Provisional Application No. 62/912,442; U.S. patent application Ser. No. 16/867,804; and U.S. Provisional Application No. 63/046,301 are specifically incorporated herein by reference.

The MRTS 106 comprises an amplifier 202, which is illustratively a variable-gain amplifier (VGA) connected to a mixer 203. The mixer 203 is an in-phase (I)-quadrature (Q) mixer (IQ mixer), or I-Q modulator, which for reasons described below, is beneficially a single-sideband IQ mixer, with standard 90° phasing of the RF signal, resulting in an output of either the upper sideband (USB) or the lower sideband (LSB), rejecting the LSB or USB, respectively. Alternatively, the I-Q mixer 203 may be adapted for binary phase modulation (BPM), quaternary phase modulation (QPM), 8-phase modulation, 16-QAM, and the like. As discussed below, the modulation is selected to provide the desired degree of approximation of the difference phase symbols. Notably, approximation of the amplitude can be carried out by the I-Q mixer 203 using techniques within the purview of the ordinarily skilled artisan.

Notably, the amplifier 202 of representative embodiments provides two illustrative beneficial functions. I-Q mixers are known to suffer conversion loss, so in order to emulate targets having comparatively large radar cross sections (RCS's), amplification is required. Moreover, the VGA is useful to selectively vary the RCS. Simply reducing the strength of the I and Q drives is undesirable because this passes along a strong unshifted carrier frequency signal which could result in an undesired ghost target.

The output of the I-Q mixer 203 is provided to a variable attenuator 204, which selectively alters the output signal provided from the mixer 203 to provide a desired return signal to the radar DUT 102. Specifically, the attenuation of the signal from the mixer 203 by the variable attenuator 204 beneficially provides a desired emulated radar cross section (RCS) of the target. As alluded to above, the amplifier 202 and the variable attenuator 204 are connected to the computer 112. Based on instructions in the memory 118, the processor 116 executes control signals to be provided by the computer 112 to the variable attenuator 204, to enable a desired level of emulation of the re-illuminated signal received from the radar DUT 102 at a reception antenna 208 and returned to the radar DUT 102 from the reillumination antenna 209.

In certain representative embodiments, the reception antenna 208 and the reillumination antenna 209 are horns selected for the wavelength of signals received from and returned to the radar DUT 102. The reception antenna 208 may have a variable gain and may be coupled to a beam-shaping element, such as a lens to tailor a degree of freedom of an angle of arrival (AoA) from the radar DUT 102. The horn or similar antenna are not essential for the reception antenna 208 and the reillumination antenna 209, and other types of antennae, such as patch antennae or patch antennae arrays, may be incorporated without departing from the scope of the present teachings.

Notably, power is used to emulate consistent radar cross-section (RCS). The RCS can be stored in look-up in tables in memory 118, for example. To this end, for a given range r, it is known that the return signal is proportional to RCS and falls as 1/r⁴. A vehicle is typically quoted as being 10 dBsm, which is radar speak for measuring area, meaning 10 dB relative to a square meter (s.m.), or in plain English, 10 square meters. Many objects have been tabulated (people, bicyclists, buildings, etc.), and those that have not can be calculated these days by ray tracing techniques. By the present teachings, emphasis is placed on providing a return signal strength to the radar DUT 102 that is commensurate with the distance r (obeying the well-known 1/r⁴ radar decay law) and the accepted value of RCS for the particular object. In accordance with a representative embodiment, the signal strength (and thus power) is adjusted by adjusting the strength of the I/Q drive signals from the computer 112 to the MRTS's 106 of the various embodiments, with a weaker I/Q drive signal providing a comparatively weaker emulation signal. Notably, in certain representative embodiments, the computer 112 precomputes the consistent return signal provided to the single point of focus at the radar DUT 102, and the controller 114 then adjusts the strength of the I and Q drives to achieve this SSB strength. Alternatively, and beneficially, the gain of amplifier 202, or the attenuation by the variable attenuator 204, or both can be adjusted by action of the controller 114 to control return SSB strength.

When the vehicular radar is an FMCW device, the distance/velocity is emulated electronically using the MRTS's 106. To this end, FMCW radar systems use chirped waveforms, whereby the correlation of the original transmit (Tx) waveform from the radar DUT 102 with the received (Rx) echo waveform reveals the target distance. For example, in upchirp/downchirp systems with chirp rates of ±k_{sw} (measured in Hz/sec), a target at a distance d and zero relative velocity to the ego vehicle will result in a frequency shift (of) given by Equation (1), where c is the speed of light and the factor of 2 is due to the roundtrip propagation of the signal from the radar DUT 102:

δf=−(±2k_{sw}d/c) Equation (1)

The sign of the shift depends on which part of the waveform, upchirp vs. downchirp, is being processed. In contrast, Doppler shifts due to relative velocity manifest as “common mode” frequency shifts; e.g., a net upshift over both halves of the waveform indicates the radar DUT is approaching closer to the target. Correlation is performed in the DUT's IF/baseband processor; bandwidths of a few MHz are typical.

The most commonly deployed variation of FMCW uses repetitive upchirps, or repetitive downchirps, but not both (with intervening dead times). As such, the distance to a target is determined as in the previous paragraph, now without the sign issue. Relative velocity is determined by measuring the phase shift between successive frame IF correlation signals, where frame is a term of art for one period of the waveform. In many FMCW radar applications, the frame repetition rate is typically a few kHz.

Frequency-shifting the chirp signals of FMCW radar is equivalent to time-shifting and hence implements an inferred excess range. If k_{sw} is the chirp slope, d₀ is the setup distance (including waveguide distances in the MRTS's 106, and d₁ is the desired emulation distance, then the required intermediate frequency f_{IF} (intermediate frequency) shift is:

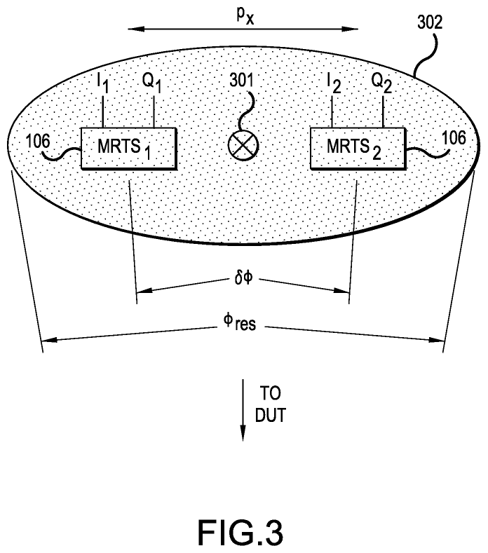

f_{IF}=2k_{sw}(d₁−d₀)/c Equation (2)

where c is the speed of light and the factor of 2 is due to the roundtrip propagation. Referring to FIGS. 1A, 1B and 3, if neighbor MRTS's 106 are positioned at ½ the resolution specification of the radar DUT 102 and at the same set up distance d₀, the radar DUT 102 will perceive them as a single target at interpolant point 301, when operated at equal drive frequency f_{IF} and amplitude. Moreover, the adjacent MRTS₁ 106 and MRTS₂ 106 depicted in FIG. 3 are operated at equal phase, with I₁ and I₂ in phase with each other, and Q₁ and Q₂ are in phase with each other, but the respective in-phase (I) and quadrature (Q) component 90° out of phase with each other. Notably, in the presently depicted illustrative embodiment, the drive frequency and amplitude of excitation of MRTS₁ and MRTS₂ are both equal, so interpolant point 301 is disposed half-way between MRTS₁ and MRTS₂ and a bisecting midpoint.

The perceived angular position of the interpolant point 301 is determined by selecting the amplitude of the retransmitted signal from the reillumination antenna 209 of the MRTS 106. To this end, if the phasing of the adjacent MRTS₁ 106 and MRTS₂ 106 of FIG. 3 remains as described above, the perceived angular position of the target is selected by providing control signals from the controller 114 to the amplifier 202 and the variable attenuator 204 that alter the amplitudes of the retransmitted signals from the respective reillumination antennas 209 of the adjacent MRTS's 106 to a selected magnitude to alter the perceived angular position of the target. As such, if the control signals from the controller 114 result in the same amplitude output signals from the adjacent MRTS's 106, the target emulated will remain at the interpolant point 301 as shown. However, if amplitude weighting provided by the controller 114 is not equal (e.g., the ratio of the output power from MRTS₁ 106 to MRTS₂ 106 of FIG. 3), then the perceived position of the interpolant point 301 will shift closer to MRTS₁ 106 and farther from MRTS₂ 106, depending on the relative weighting. Also, the perceived RCS is given by the weighted sum of the individual RCS's of each MRTS 106 The RCS coordination works quite similarly to the well-known microwave power combining method of quasi-optical “grid amplifiers”.

With specific reference to FIG. 3, full width, half max (FWHM) resolution of the radar DUT 102 is depicted by ellipse 302. When MRTS₁ 106 to MRTS₂ 106 are spaced finer than this resolution, e.g., δϕ=ϕᵣₑₛ/2, if active, MRTS₁ 106 to MRTS₂ 106 are perceived as a single target at an intermediate centroid, the interpolant point 301 at the center of the ellipse 302. The angular resolution of radar devices (e.g. radar DUT 102) is typically sixteen (16) times coarser than its angular accuracy specification. By selecting δϕ=ϕᵣₑₛ/2 and δθ=θᵣₑₛ/2, an approximately eight-fold (8 times) reduction in the number of MRTS's 106 is realized for a linear (1D) array re-illuminator 101; and an approximately 64-fold reduction in required MRTS's 106 for a 2D (x-y in the coordinate system of FIG. 1B) array re-illuminator 101.

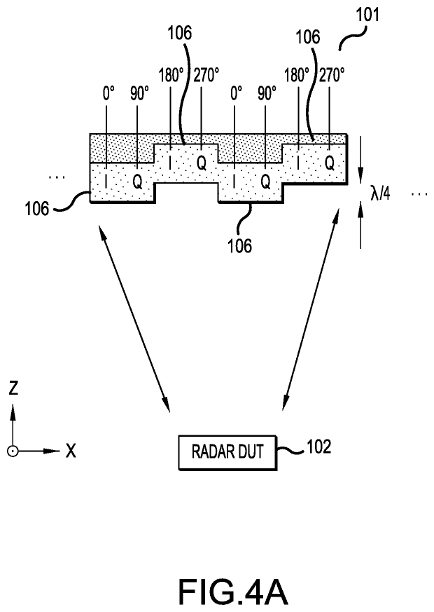

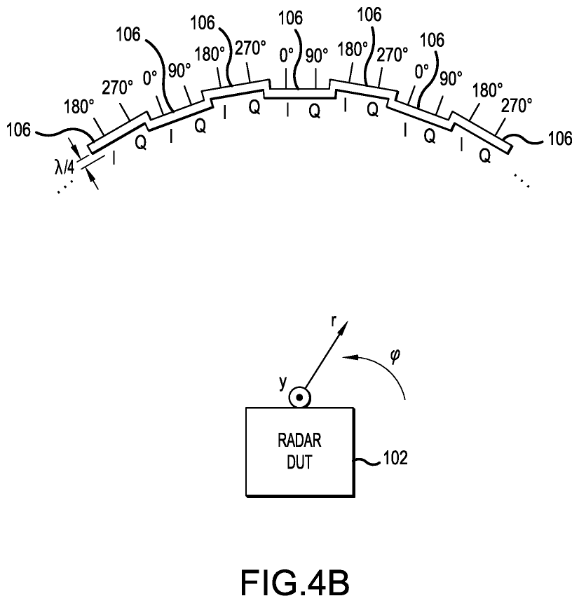

FIG. 4A shows adjacent offset MRTS's 106 disposed and controlled to suppress ghost images in accordance with a representative embodiment. Certain aspects of the adjacent MRTS's 106 described in connection with FIG. 4A are common to the re-illuminators 101 and arrays of MRTS's 106 described above in connection with FIGS. 1A-3, and in the incorporated provisional application and patent application noted above, and attached hereto. Details of common aspects are not necessarily repeated.

One type of ghost signal that can occur in systems for emulating scenery for a radar DUT results from the components used in the emulation set up, and the ghost signals are often referred to as “setup ghost signals” resulting from reflection from the mechanical/physical hardware of the system itself. Just by way of illustration, the array of MRTS's 106 in FIGS. 1A-1B may be disposed as close as a one (1) meter from the radar DUT 102 during testing of the radar DUT 102. Locating the array of MRTS's 106 one meter from the radar DUT 102, if unmitigated, can result in ghost signals in front of the vehicle having a radar unit disposed therein. Just by way of illustration, in certain known emulation systems, a related ghost is the carrier-leakage ghost, whereby some amount of the original chirp signal leaks through the mixer without frequency shift. This carrier leakage is retransmitted to the radar with only a slight delay compared to the setup ghost. As such, this carrier leakage is manifest as a ghost, for example at 1.2 m, from the vehicle.

Furthermore, ghost signals known as range ghost can appear near integer multiples of the desired simulated target (simulant) in the array of MRTS's 106. For example, mixers have nonlinearities whereby harmonics of the I-Q drive signals can also mix with the millimeter-wave RF signal. When this happens, according to Eqn. (1), the 2^{nd} harmonic introduces a range ghost at d₂=2d₁−d₀ and the 3^{rd} harmonic introduces a range ghost at d₃=3d₁−2d₀, etc.

Another type of range ghost occurs due to multi-pass frequency-shifting when pickup-retransmit isolation is poor. In this case, the original chirp signal gets frequency-shifted once upon the first pass through the transponder, but it reenters the pickup antenna to be frequency-shifted again. Of course, this looping behavior can occur again and again, leading to a series of ghosts that appear almost at the same distances as the nonlinear harmonic ghosts of the previous paragraph. In fact, the distance separation between the n^{th}-pass looping ghost signal and the n^{th} harmonic ghost is about the same as the distance between the carrier leakage ghost signal and the setup ghost signal. For ease of description, MRTS's 106 are disposed along the z-axis in the coordinate system of FIG. 4A and staggered in the azimuth (x-axis) direction. Similarly, MRTS's 106 are also staggered along the z-axis (elevation) as one traverses MRTS's 106 in the elevation (y-axis) direction in order to increase ghost suppression. The perceived ghost angle is often straight ahead (x direction) due to the collective action of the returning ghost wave from the MRTS's 106.

In accordance with a representative embodiment, the first and third MRTS's 106 (from left to right in FIG. 4A) are designated as the odd MRTS's 106 and are disposed at odd azimuth positions. By contrast, second and fourth MRTS's 106 (from left to right in FIG. 4A) are designated as the even MRTS's 106 and are disposed at even azimuth positions. The even MRTS's 106 are staggered from the odd MRTS's 106 in setup distance from the radar DUT by λ/4 where λ is the wavelength of the radar DUT 102. As such, the roundtrip difference between even MRTS's 106 and odd MRTS's is therefore λ/2, or 180° in electrical phase.

Without selective phasing of the respective MRTS's, all signals (ghosts and simulant) would suffer destructive interference returning to the radar DUT 102. In order to avoid suppressing the stimulant signals from being incident on the radar DUT 102, the phase of the even (e) MRTS's 106 is set by the controller 114 so that the phase of the in-phase component is set to ϕ(Iₑ)=0°, and the quadrature component is set to ϕ(Qₑ)=90°, and the phase of the odd MRTS's 106 is set so ϕ(Iₒ)=180°, ϕ(Qₒ)=270°, where ϕ denotes the phase function. In combination with the physical staggering of the MRTS's 106 noted above, at the even MRTS's 106 the simulant signal is returned with 0°+0°=0° net phase and at the odd MRTS's 106 the simulant signal it is returned with 180°+180°=0° mod 360°, where the net phase is the sum of the physical stagger delay and the IF drive. As desired, the two partial simulant signals are in phase and hence add constructively in return to the DUT. Table I is a suppression table that shows the net phase of the even and odd MRTS's 106 depicted in FIG. 4A and the resultant effect on the simulant and ghost signals:

| | Even MRTS | | |
|---|---|---|---|
| Signal type | net phase | Odd MRTS net phase | Suppressed? |
| Simulant | 0° | 360° = 0° mod 360° | No |
| Setup ghost | 0° | 180° | Yes |
| Carrier leakage | 0° | 180° | Yes |
| Nonlinear 2^{nd} | 0° | 540° = 180° mod 360° | Yes |
| harmonic | | | |
| 2-pass looping ghost | 0° | 540° = 180° mod 360° | Yes |

Notably, Table 1 applies when either an interpolant is disposed midway between grid points (MRTS's 106) such as described above in connection with FIG. 3. Moreover, when the amplitude weights of the neighboring even and odd MRTS's are essentially equal, the coordinated interference of the return signals are either strictly constructive or strictly destructive.

FIG. 4B shows adjacent offset MRTS's 106 disposed and controlled to suppress ghost images in accordance with a representative embodiment. As will be appreciated, the arrangement of MRTS's 106 of the representative embodiments of FIG. 4B is “curved” as opposed to the linear arrangement of the MRTS's 106 of FIG. 4A. Certain aspects of the adjacent MRTS's 106 described in connection with FIG. 4B are common to the re-illuminators 101 and arrays of MRTS's 106 described above in connection with FIGS. 1A-4A, and in the incorporated provisional application and patent application noted above and attached hereto. Details of common aspects are not necessarily repeated.

For ease of description, MRTS's 106 are radially staggered in the azimuth (φ) direction as shown in FIG. 4B. Similarly, MRTS's 106 are also z-axis staggered as one traverses pixels in the elevation (y-axis) direction in order to increase ghost suppression. The perceived ghost angle is often straight ahead (x direction) due to the collective action of the returning ghost wave from the MRTS's 106.

In accordance with a representative embodiment, the first and third MRTS's 106 (from left to right in FIG. 4B) are designated as the odd MRTS's 106 and are disposed at odd azimuth positions. By contrast, second and fourth MRTS's 106 (from left to right in FIG. 4B) are designated as the even MRTS's 106 and are disposed at even azimuth positions. As in the representative embodiments described in connection with FIG. 4A, the even MRTS's 106 are staggered from the odd MRTS's 106 in setup distance from the radar DUT by λ/4 where λ is the wavelength of the radar DUT 102. As such, the roundtrip difference between even MRTS's 106 and odd MRTS's is therefore λ/2, or 180° in electrical phase.

Without mitigation to suppress ghost signals even relative to selective phasing of the respective MRTS's, all signals (ghosts and simulant) would suffer destructive interference returning to the radar DUT 102. In order to avoid suppressing the stimulant signals from being incident on the radar DUT 102, the phase of the even (e) MRTS's 106 is set by the controller 114 so that the phase of the in-phase component is set to ϕ(Iₑ)=0°, and the quadrature component is set to ϕ(Qₑ)=90°, and the phase of the odd MRTS's 106 is set so ϕ(Iₒ)=180°, ϕ(Qₒ)=270°, where ϕ denotes the phase function. In combination with the physical staggering of the MRTS's 106 noted above, at the even MRTS's 106 the simulant signal is returned with 0°+0°=0° net phase and at the odd MRTS's 106 the simulant signal it is returned with 180°+180°=0° mod 360°, where the net phase is the sum of the physical stagger delay and the IF drive. As desired, the two partial simulant signals are in phase and hence add constructively in return to the DUT.

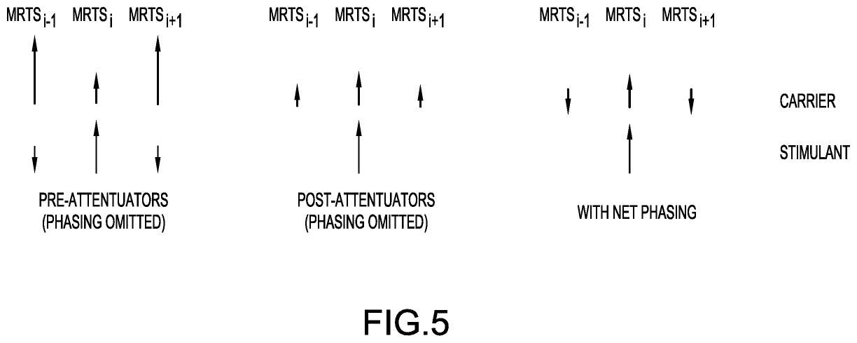

Another case is described in connection with FIG. 5, which shows emulation of a target consisting of a single isolated MRTS 106 (pixel) in accordance with a representative embodiment. Again, certain aspects of the presently described representative embodiment are common to the re-illuminators 101 and arrays of MRTS's 106 described above in connection with FIGS. 1A-4, and in the incorporated provisional application and patent application noted above and attached hereto. Details of common aspects are not necessarily repeated. Notably, in FIG. 5, lengths of arrows denote signal tone powers.

In FIG. 5 a target consists of a single pixel (single MRTS). This is often true for a distant target and hence a weaker return signal is emulated. At the MRTS pixel of interest the I-Q drive is moderate, and, as such there is no need for strong drive signals from the controller 114 to be provided to the MRTS's since the emulated target is at a comparatively large distance. The MRTS's neighboring one MRTS has an I-Q drive signal that is reduced further or possibly shut off. In analog mixers when the I-Q drive signal is comparatively weak, more carrier leakage occurs. As such, the attenuation provided by the respective variable attenuators (see FIG. 2) on the neighbor MRTS's is increased so that the total carrier leakage power of the neighbor MRTS's matches the carrier leakage power of the MRTS of interest. Since the neighbor drive signals are already small, their SSB tones are small, and the high attenuation pushes them below noise level. As such, the SSB tones of the adjacent MSTS's are invisible to the radar DUT 102.

In the presently described embodiment, even and odd cancellation of the nonlinear 2^{nd} harmonic and 2-pass looping ghosts is not realized, because the neighbor MRTS's emit negligible 2f_{IF} power due to the very weak I-Q drive and the high attenuation. However, this is acceptable since the MRTS pixel itself experiences only moderate I-Q drive signal from the controller and a relatively well-designed mixer together with reasonable pickup-retransmit isolation will avoid range ghosts at and near d₂.

Table II below is a suppression table when a target is on an isolated MRTS pixel.

| Signal type | Suppression mechanism |
|---|---|
| Simulant | Unsuppressed |
| Setup ghost | Physical 180° e-o stagger |
| Carrier leakage | Leakage balancing with nontarget neighbors |
| | and physical 180° e-o stagger |
| Nonlinear 2^{nd} harmonic | Moderate to weak I-Q drive and good mixer |
| ghost | design |
| 2-pass looping ghost | Moderate to weak I-Q drive and good |
| | pickup-retransmit isolation |

Finally, intermediate cases such as interpolant points that are neither midway between pixel grid points, which are the locations (e.g., coordinates in x,y (not shown in FIG. 5) of the pixels, where a grid is a 2D array of MRTSs, or exactly on grid are simply handled in an intermediate fashion between the ghost suppression methods of FIGS. 4 and 5. For example, the drive signals from the controller 114 to the I-Q mixer (see FIG. 2) and attenuation levels set by the controller 114 for the variable attenuators (see FIG. 2) of successive neighbors are adjusted to achieve the weights representing the desired interpolant position and perceived RCS as described above in connection with FIG. 3; but also to maximize suppression of the carrier leakage. Referring to FIG. 3 (but now with the λ/4 physical stagger as well as the even vs. odd IF phasing discussed in above Table I), there are the desirables (the 2 simulant weights and the leakage balance) but 4 real variables that can be controlled: drive strength, I₂-Q₂ drive strength, attenuation level of MTRS₁, and the attenuation level of MRTS₂), so quite generally there is always a solution set.

In view of the foregoing, the present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

Although various target emulations for automobile radar systems have been described with reference to several representative embodiments, it is understood that the words that have been used are words of description and illustration, rather than words of limitation. Changes may be made within the purview of the appended claims, as presently stated and as amended, without departing from the scope and spirit of dynamic echo signal emulation for automobile radar sensor configurations in its aspects. Although dynamic echo signal emulation for automobile radar sensor configurations has been described with reference to particular means, materials and embodiments, dynamic echo signal emulation for automobile radar sensor configurations is not intended to be limited to the particulars disclosed; rather dynamic echo signal emulation for automobile radar sensor configurations extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “teachings” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A system for testing vehicular radar, comprising:
a re-illumination element adapted to receive electromagnetic waves, the re-illumination element being adapted to transmit response signals, the re-illumination element comprising:
a plurality of miniature radar target simulators (MRTS's), each comprising: a receive antenna; a variable gain amplifier (VGA); an in-phase-quadrature (IQ) mixer; a variable attenuator; and a transmit antenna, the MRTS's being disposed in an array comprising rows and columns of the MRTS's, wherein: each MRTS of the array is laterally spaced a distance pₓ and vertically spaced a distance p_{y} from an adjacent MRTS; and an incremental subtended azimuth angle (δϕ) and an incremental subtended elevation (δθ) angle are finer than an azimuth resolution specification (ϕᵣₑₛ) and an elevation resolution specification (θᵣₑₛ) of a radar device under test (DUT).

2. The system of claim 1, wherein the re-illumination element is adapted to emulate an apparent target distance, or an apparent target velocity, or both.

3. The system of claim 1, wherein the each MRTS of the array is laterally spaced a distance pₓ and vertically spaced a distance p_{y} from an adjacent MRTS, wherein an incremental subtended azimuth angle (δϕ) and an incremental subtended elevation (δθ) angle are finer than an azimuth resolution specification (ϕᵣₑₛ) and an elevation resolution specification (θᵣₑₛ) of a radar device under test (DUT).

4. The system of claim 3, wherein the incremental subtended azimuth angle (δϕ) is approximately one-half of the azimuth resolution specification (ϕᵣₑₛ/2).

5. The system of claim 3, wherein the incremental elevation angle (δθ) is approximately one-half of the elevation resolution specification (θᵣₑₛ/2).

6. The system of claim 3, wherein the incremental subtended azimuth angle (δϕ) is approximately one-half of the azimuth resolution specification (ϕᵣₑₛ/2), and the incremental elevation angle (δθ) is approximately one-half of the elevation resolution specification (θᵣₑₛ/2).

7. A system for testing vehicular radar, comprising:
a re-illumination element adapted to receive electromagnetic waves, the re-illumination element being adapted to transmit response signals, the re-illumination element comprising:
a plurality of miniature radar target simulators (MRTS's), each comprising: a receive antenna; a variable gain amplifier (VGA); an in-phase-quadrature (IQ) mixer; a variable attenuator; and a transmit antenna, the MRTS's being disposed in an array comprising rows and columns of the MRTS's, the VGA and the variable attenuator being configured to control an emulated radar cross section (RCS) of a target, wherein the array comprises a plurality of MRTS's staggered in displacement from a device under test (DUT).

8. The system of claim 7, wherein the row of MRTS's are staggered in an azimuthal direction, and the columns of MRTS's are staggered in an elevation direction.

9. The system of claim 8, wherein the rows of the MRTS's are even MRTS's and odd MRTS's, and the even MRTS's and the odd MRTS's are displaced from one another by a distance from the DUT equal to λ/4 where λ is a wavelength of the DUT, the even MRTS's each comprising even in-phase an quadrature (IQ) mixers, and the odd MRTS's each comprising an odd IQ mixer, the even MRTS's being driven by IF phases 0° and 90°, and the odd MRTS's being driven by IF phases 180° and 270°.

10. The system of claim 8, wherein the columns of MRTS's are even MRTS's and odd MRTS's, the even MRTS's and the odd MRTS's are displaced from one another by a distance from the DUT equal to λ/4 where λ is a wavelength of the DUT, the even MRTS's each comprising even in-phase an quadrature (IQ) mixers, and the odd MRTS's each comprising an odd IQ mixer, the even MRTS's being driven by IF phases 0° and 90°, and the odd MRTS's being driven by IF phases 180° and 270°.

11. A system for testing vehicular radar, comprising:
a re-illumination element adapted to receive electromagnetic waves, the re-illumination element being adapted to transmit response signals, the re-illumination element comprising:
a plurality of miniature radar target simulators (MRTS's), each comprising: a receive antenna; a variable gain amplifier (VGA); an in-phase-quadrature (IQ) mixer; a variable attenuator; and a transmit antenna, the MRTS's being disposed in an array comprising rows and columns of the MRTS's, wherein: the each MRTS of the array is laterally spaced a distance pₓ and vertically spaced a distance p_{y} from an adjacent MRTS; and an incremental subtended azimuth angle (δϕ) and an incremental subtended elevation (δθ) angle are finer than an azimuth resolution specification (ϕᵣₑₛ) and an elevation resolution specification (θᵣₑₛ) of a radar device under test (DUT); and
a controller comprising a memory that stores instructions, and a processor that executes the instructions, wherein the controller controls the re-illumination element and is configured to perform performance testing on the vehicular radar that includes a plurality of targets.

12. The system of claim 11, wherein the re-illumination element is adapted to emulate an apparent target distance, or an apparent target velocity, or both.

13. The system of claim 11, wherein the incremental subtended azimuth angle (δϕ) is approximately one-half of the azimuth resolution specification (ϕᵣₑₛ/2).

14. The system of claim 11, wherein the incremental elevation angle (δθ) is approximately one-half of the elevation resolution specification (θᵣₑₛ/2).

15. The system of claim 11, wherein the incremental subtended azimuth angle (δϕ) is approximately one-half of the azimuth resolution specification (ϕᵣₑₛ/2), and the incremental elevation angle (δθ) is approximately one-half of the elevation resolution specification (θᵣₑₛ/2).

16. The system of claim 11, wherein the array comprises a plurality of MRTS's staggered in displacement from a device under test (DUT).

17. The system of claim 16, wherein the row of MRTS's are staggered in an azimuthal direction, and the columns of MRTS's are staggered in an elevation direction.

18. The system of claim 17, wherein the rows of the MRTS's are even MRTS's and odd MRTS's, wherein the even MRTS's and the odd MRTS's are displaced from one another by a distance from the DUT equal to λ/4 where λ is a wavelength of the DUT, the even MRTS's each comprising even in-phase an quadrature (IQ) mixers, and the odd MRTS's each comprising an odd IQ mixer, the even MRTS's being driven by IF phases 0° and 90°, and the odd MRTS's being driven by IF phases 180° and 270°.

19. The system of claim 17, wherein the columns of MRTS's are even MRTS's and odd MRTS's, wherein the even MRTS's and the odd MRTS's are displaced from one another by a distance from the DUT equal to λ/4 where λ is a wavelength of the DUT, the even MRTS's each comprising even in-phase an quadrature (IQ) mixers, and the odd MRTS's each comprising an odd IQ mixer, the even MRTS's being driven by IF phases 0° and 90°, and the odd MRTS's being driven by IF phases 180° and 270°.
